(19) United States
(12) Patent Application Publication
(10) Pub. No.: US 2007/0282891 A1
(43) Pub. Date: Dec. 6, 2007

(54) HIERARCHICAL PROTOCOL REPRESENTATION FOR DATA ACQUISITION AND CONTROL SYSTEM

(76) Inventor: Vladimir Avdonin, Iowa City, IA (US)

Correspondence Address: Vladimir Avdonin, 920 Weeber St., Iowa City, IA, 52246, US

(21) Appl. No.: 11/738,548

(22) Filed: Apr. 23, 2007

Related U.S. Application Data
(60) Provisional application No. 60/746,047, filed on Apr. 30, 2006.

(51) Int. Cl. G06F 17/00

(52) U.S. Cl. 707/102; 707/E17.005

(57) ABSTRACT

Protocol is information about sequence of actions including starting and stopping recording, producing stimulation on different channels and data processing and information about time when the actions are to happen. The properties of protocol are described by data objects in memory that are arranged in tree hierarchy. Top level objects include resource objects that describe system resources engaged in operation, event objects that specify moment of time during operation, action objects that specify act of operation by resource. Properties of the object are specified by its descendant data objects or are assigned a default value when the object for the property is not present. The hierarchy is displayed on display and operator can add, delete or modify objects. A copy of protocol is saved in serialized form into computer file together with data recorded during execution of the protocol.

### CROSS-REFERENCE TO RELATED APPLICATIONS

This application claims the benefit of Provisional Application Ser. No. 60/746,047, filed on Apr., 30, 2006 by the present inventor, which is incorporated by reference.

### BACKGROUND OF THE INVENTION

1. Field of Invention

This invention generally relates to data acquisition and control system and more specifically to programming such system for performing its functions in predefined sequence and at predetermined moments of time.

2. Prior Art

Many tasks in science and engineering can be formally described as a series of actions on the subject that shall be performed in predefined sequence and at predetermined moments of time. The actions can be broadly divided onto two classes—stimulation that changes the state of the subject, and registration that records some characteristic of the subject for further analysis. Such sequence of actions is referred to as a recording protocol or just a protocol.

An increasing number of application areas employs computer automation for performing such tasks. As a result there is a demand on adequate means for relaying recording protocol from human operator to the automated system with an emphasis on convenience for operator.

The first approaches used text-based scripting in computer programming languages. Although this means is appropriate in many situations it has obvious disadvantages in placing on operator responsibility to maintain not only correctness of recording protocol in terms of application area, but also the correctness of the representation in terms of computer language and operations with operating system and hardware. Protocol expressed as computer program may be hard to create, modify and interpret by collaborators of the author of the protocol.

An introduction of a graphical user interface enabled a variety of means to represent recording protocols. Some went along the way of graphical representation of computer program where multiple graphical symbols representing program operations are connected according to control flow or data flow (as in U.S. Pat. No. 4,901,221) in the system. These means being related to general purpose programming inherit the disadvantages of text based scripting with respect to recording protocol implementation. In particular, it is hard to create, interpret and modify the protocol because such representation involves operating in terms of programming the system and not in terms of the subject of the protocol.

Another approach is to represent the protocol as a sequence of actions from predefined set in a form of a table (as in software package pCLAMP from Axon Instruments) or a flowchart (as in U.S. Pat. No. 5,442,746). The user specifies the properties of protocol with the mean of static screen forms containing edit fields. This approach allows to operate mostly in terms of subject of the application field. The sequence of actions is quite obvious from examining the protocol. One disadvantage of this approach is that during creating and modifying the protocol the user have to visit multiple forms that often may be visually and/or logically unrelated. Another disadvantage is that adding new features to the system may require significant changes to property forms, including creating new edit fields and form and moving existing edit fields, which requires efforts both from developer and from user who have to learn new layout.

### SUMMARY

The present invention provides the hierarchical representation of the recording protocol that:
enables creating of the protocol in terms of the application area;
provides visual relations between protocol elements that facilitates editing and interpreting the protocol;
may be easily applied to different application areas without need to reprogram the system;

### DRAWINGS

FIG. 1 A block diagram of an example data acquisition system that can utilize the invented method.

FIG. 2 A class diagram for base class of Protocol class.

FIG. 3 A class diagram for Protocol class.

FIG. 4 A class diagram for ProtocolUnit class.

FIG. 5 An example of GUI representation of an example protocol.

### DETAILED DESCRIPTION

1. Example Data Acquisition System

A block diagram of an example data acquisition system that can utilize the invented method is shown on FIG. 1. The operator or user interacts with the system via a software application running on a computer workstation 101. The software application running on the workstation controls all the external devices 102-104. An external devices interacts with a monitored physical system 105 by either measuring various physical characteristics of the system or by producing physical actions upon the monitored system. Each device has one or more data channels that are used for data exchange with the computer 101. Every measured characteristic is associated with an input data channel of the device. Every controlled (stimulated) physical characteristics is associated with an output data channel. The devices sample physical values and produce stimulation either one sample at a time or as a series of samples separated by constant time interval. In either case the time of each sample shall be defined with a certain precision with respect to other samples on all the channels.

The following are examples of device types that can be included in the acquisition system and data types they exchange over their data channels:
discrete interface device 102 can produce stepwise actions on the system (for example, opening illumination shutter), or monitor for abrupt changes of the system properties (for example, phase transition). A single datum for such a device is one or more digital bits.
analog interface device 103 with a channels representing continuous physical value. A single datum is either floating point or integer number.
image acquisition device 104 with a channel representing two dimensional field of continuous physical values. A single datum is an array of numbers.

During a single act of operation, or an experiment, the data acquisition system simultaneously performs reading and writing of data over different channels of different devices in a predefined sequence or recording protocol, as specified by the user. The user designs the recording protocol prior to an experiment and enters it into the system according to the invented method. The data read during the experiment are stored by the computer together with the recording protocol. This allows to deduce a moment of time when each recorded datum was acquired and what were the stimulation values at that moment. The information about a recording protocol and recorded data is stored in a single computer file using hierarchical structure according to the invention.

2. Base Object Hierarchy

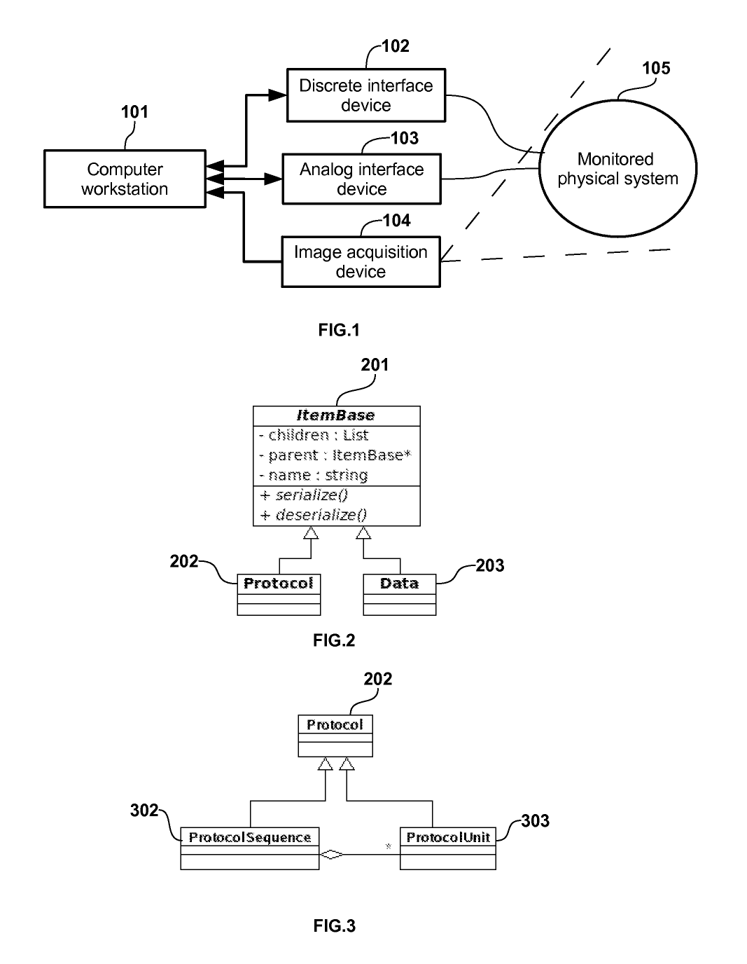

A class diagram on FIG. 2 shows that the class Data 202 representing the recorded data information and class Protocol 203 representing recording protocol information are derived from the same base class ItemBase 201. The base class provides for the tree containment hierarchy by its “children” and “parent” attributes. The “parent” attribute is a reference to an ItemBase object one level up in the hierarchy, and the “children” attribute is a list of ItemBase items one level down in the hierarchy. With the methods serialize/deserialize the ItemBase class defines the protocol for saving/loading the object to/from a file. Every class inheriting from ItemBase implements these methods and so that the whole hierarchy can be save and restored. All the properties of Data and Protocol objects that have to be persistent are represented by their children objects that also are derived from ItemBase. Any such objects may in turn have collection of properties represented in the same way. The name of a property is stored in the “name” attribute of its object. To distinguish from the names of attributes the names of property objects will be given in quotas with first character capitalized. Subclasses of ItemBase for elemental data types such as Boolean, Number, String and Enumeration are defined. Elemental data types usually do not have have children and their properties are contained within the class attributes and are made persistent by elemental class implementation of serialization protocol. Non-elemental data types having multiple data such as sequence of samples or images may either store there data values within attributes or may have attributes that refer to the location of data array that is stored in a separate location in computer memory and/or computer file on hard drive.

3. Object Representation of Protocol

A class diagram on FIG. 3 shows the two forms of recording protocol 202: ProtocolUnit 303 is an actual collection of instructions describing an experiment, and ProtocolSequence 302 is a sequence of references to the objects of ProtocolUnit class. Each reference may have a optional “Count” property specifying the repetition count for execution of the ProtocolUnit object. The ProtocolSequence allows reusing of recording protocols building blocks.

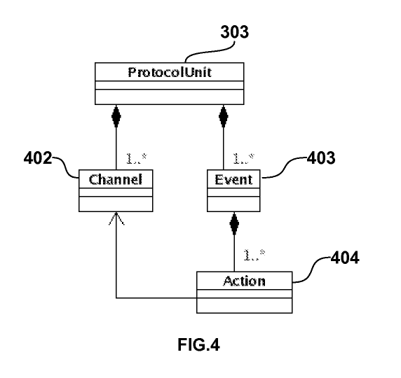

The hierarchy of ProtocolUnit class 303 is shown on FIG. 4. The property objects of Channel class 402 specify the device channels that will transmit data during the execution of the recording protocol. The Channel object is linked to its device channel based on its “Name” property. The required property of the channel is “Direction”, that specifies whether the referenced channel is input or output. The input channel shall contain a property specifying sampling period. The Channel may contain any additional properties meaningful for the referenced channel, for example, a value of exposure for an image input channel. In order for ProtocolUnit object to be valid for execution by the acquisition system it shall contain at least one property object of the Channel class.

An object of Event class 403 specifies a moment of time during the execution of the protocol. The required property of any Event object is “Delay” that specifies the time duration measured from reference point. By default the delay references to the beginning of protocol execution for the first event, or to the moment of execution of the previous event. The Event object can contain “Reference event” property that provides explicit reference other than default that shall be used as a time reference. In order for ProtocolUnit object to be valid for execution by the acquisition system it shall contain at least one property object of Event class.

The object of event class can contain one or more properties of the Action class 404. This class specify an action performed on a channel in the moment of time specified by its parent Event object. An Action object refers to the Channel class 402 object through the required “Channel name” property. An “Action type” is a required property that specifies the type of action to be performed on the channel referenced by “Channel name” property. Valid types of action depend on the direction of the channel. For input channel there are two action types: start recording and stop recording. For output channel the actions can be output constant value, output series of values and start waveform output. Actions for output channels may have additional properties specifying the characteristics of requested output. For output constant value action the property specifying the constant value to be sent to the output channel may be present. If such property is not specified the default value shall be used—the value that the channel had prior to starting of the recording. For output series of values action the property shall be present containing the output series either as a reference to external file containing the data or a list of numeric objects. For start waveform output action the properties shall be present specifying the kind of waveform, its amplitude, period, and any other properties specific for a particular waveform kind, for example, duty cycle for rectangular pulse.

A ProtocolUnit object may contain one property object “Count” of Number class that specifies number of iterations of the recording protocol. On each iteration some of the numeric properties of Event objects and Action objects for output channels can be modified in order to establish independent variable parameter in the series of measurements or recordings. For an Event object a value of “Delay” property can be varied, for an Action object any property describing the output such as “Amplitude” can be made variable. A value variability is specified by adding one of the following properties to the object:
“Increment” property for linear change of the value with each protocol iteration;
“Multiplier” property for exponential change;

An “Order” property can be added to “Increment” or “Multiplier” properties to specify an order in which different values are selected in sequential executions—can be one of “Increment”, “Decrement”, “Alternate”. If “Order” property is omitted, the default is “Increment”.

A ProtocolUnit object may contain one property object “Average count” of Number class, the presence of which requests repeating for the specified number of times the execution of protocol for each set of the values varied according to the “Count” property. The data from each of input channel can be averaged on the fly or stored into the file for averaging later, or both.

A ProtocolUnit object may contain one compound property “Baseline”. The presence of this property requests additional series of execution of the protocol for every set of the values varied according to the “Count” property with additional correction applied to the variable values related to the output channels. The data recorded from the input channels during such execution can be used as a measure of background or baseline for a physical property of the monitored physical system. The correction kind is specified for every output channel by its property “Baseline output” of the Enumeration class with values “Unmodified”, “Constant” and “Scaled”. For an output channel with the correction kind “Unmodified” the data are sent in the same way as during normal execution of protocol. Output to the channel with the correction kind “Constant” is not modified during baseline recording, for example, if during normal execution the channel opens illumination shutter, with “Constant” correction kind the shutter will stay closed during background recording. For an output channel with a correction kind “Scaled” the value “Amplitude” for all actions will be multiplied by the value of “Scale” property of the Baseline object. The “Scale” correction can be used to record the response of nonlinear system in a linear region. An output channel can have “Baseline value” property that specifies the starting output, or holding value for the baseline recording. A“Baseline” object has a “Delay” property specifying time interval between normal execution execution of the protocol and execution for baseline recording, with negative values indicating that baseline recording is performed before the main recording. A Baseline object may have “Average count” property specifying a number of baseline recording repetitions made for averaging. The recording of baseline for each input data channel can be disabled by the Boolean “Record baseline” property of the Channel object with value of “No”.

A ProtocolUnit object may contain properties of an Analysis class. An object of the Analysis class describes the on-line analysis operation performed on recorded data. The “Kind” property of an Analysis object specifies the analysis procedure, for example “Average” or “Maximum”. Depending on the analysis kind one or more data channels are used as input for analysis operation and they are referenced by Analysis properties of class String set to the name of the channel. The resulting analysis will be stored into Data item, and will have the number of data points equal to the number of iterations of the protocol. An Analysis object specifies an independent variable for resulting data with an Enumeration property “X Value” with values “Index” that refers to execution count of protocol, and dynamically build list of values that refer to Event objects that have either variable time or contain Action object with variable value. The time range of data selected for the analysis is specified by two compound properties of Analysis object named “Start” and “End”. Each time specification has property “Value” specifying time offset from a reference time moment, which is the beginning of the recording by default. The time of any Event object can be specified as the reference time moment by adding to a time specification a “Reference” property of String class set to the name of the Event object.

4. Graphical User Interface Representation of a Recording Protocol

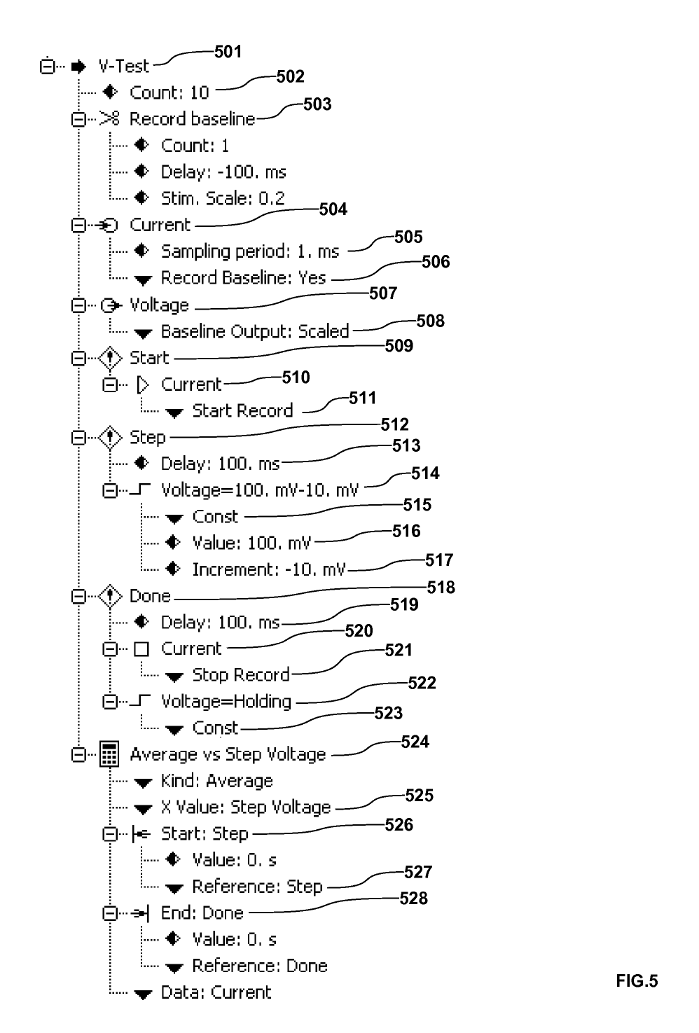

Protocol is displayed to user and is edited by user in a separate graphical user interface (GUI) window, a protocol editor. For presenting the recording protocol to the user the software preferably use the standard user interface element, a tree control, that is usually included in standard GUI toolkits of operating systems. The FIG. 5 shows an example of GUI representation of a ProtocolUnit object. Each object is shown as an item on a separate line consisting of a text label and an icon to the left of the text. An icon can be unique to an object class as for ProtocolUnit object 501, or can be a generic icon for elemental objects. There are two types of generic icons: for the items that have a text that is edited in-line (Number, String) as for “Count” property 502 (Number), and for the items that are modified by selection from a pop up menu (Boolean, Enumeration) as for “Record baseline” property 506 (Boolean). An icon for protocol channel can be changed dynamically to indicate to user if the name given to the protocol channel is known to the system as a name of one of the device data channels of the same direction. If the protocol contains any channel that can not be bound to any known device channel, the protocol can not be executed. The icon for unknown channel is different from icon of known channel to attract attention of the user to the fact that protocol can not be executed.

All protocol elements on FIG. 5 are shown fully expanded. The user can hide an item properties by clicking with the mouse on a collapse control element shown to the left of the items containing other visible items.

The text label shall describe the item in most effective way for a given context and kind of the item. A text label of an item may include:
only the name of the property object that the item represents, for example, “Record baseline” 503;
only the value of the property that the item represents in case when the name of the property is obvious from context, for example, “Action type” property (511, 515, 521, 523) of an Action object;
both the name of the property and its value, for example, “Count” property 502;
a value of hidden property object, for example, name for the protocol 501, channel 504,507 and event 509, 512, 518 items is not represented by a separate tree item, but as a text label of the item, containing the property;
a textual description summarizing contained properties so that much of item properties can be read without expanding the item, for example, action items for output channel 514 and 522;

The user can add properties to an item by selecting a command from a pop up menu associated with the item. Each item can have its own list of commands available through the menu depending on what kinds of properties can be added to the item. The list of addition commands can change dynamically depending on context, for example, if only one instance of a property can be added, its corresponding addition command is removed from the menu command list once such property has been added. The required property items are created automatically together with their parent item at the same time. An absent property is treated as if this property have the default value. For example, action item 522 does not have a “Value” child property, and a default output value before recording (holding value) is taken by default, as indicated also by the text label of the item (compare to item 514). Accordingly, instead of setting the default value by editing the property the user can delete the property to the same effect. To delete an item the user select an item and press “Delete” key. Some required properties can not be deleted. When user attempts to delete such property a dialog indicating that this property is required is shown.

5. Example of Creating and Editing Protocol with GUI

The following describes a typical sequence of steps executed by the user in order to create the example protocol shown on FIG. 5. The user creates new protocol by selecting command “New protocol” from the protocol editor menu. A new item representing a protocol 501 shall appear in the editor window. The item shall not contain any children items. The user adds an input channel 504 by selecting “Add input channel” command from protocol item 501 pop-up menu. The user edits the label of the item to give it a name, in this example “Current”. The input channel item is created with “Sampling period” item 505 already added. If there are devices already known to the system, the system can offer to select the channel from the list instead of typing the name for new channel. The same way the user creates output channel item 507 and types in a name, in this example “Voltage”. The user then appends new event 509 to the protocol by selecting “Append event” from the protocol item 501 pop up menu and typing in new name for the event, in this example “Start”. The newly created event item does not contain any children items. The user creates “Step” 512 and “Done” 518 events following the same procedure. These new events are created with respective “Delay” property items 513 and 519 added and set to the default value 100 ms. The user then creates action 510 at “Start” by selecting “Create action for Current” from the “Start” event item 509 pop up menu. The “Action type” child item 511 is automatically created inside the action item 510 and is assigned a value “Start recording” based on the knowledge that this is the first action on the input channel “Current”. The same way the user creates another action on “Current” 520 at “Done” event 518. This action is created together with child “Action type” item 521 automatically set to “Stop recording” value. The same way user creates actions 514 and 522 on “Voltage” channel at “Step” event 512 and “Done” event 518 . The actions for output channel are created with an “Action type” item 515 and 523 set to “Const” default value. The user adds “Value” 516 and “Increment” 517 items to the action 514 at “Step” event 512 by selecting respective commands from the action item 514 pop up menu and sets their values by editing the label text in-line. In order for value increment to be effective the user adds “Count” item 502 to protocol item 501 using command from the item 501 pop up menu. The value for action 522 is not specified which by default means that the value of channels before the start of protocol or holding value will be used. The text label of action item 522 “Voltage=Holding” reflects this fact. The user requests baseline recording by adding “Record baseline” item 503 to protocol item 501 using the command from the item 501 pop up menu. The “Record baseline” items is created with all children shown on the figure automatically added. Adding “Record baseline” item 503 to the protocol results in adding related items 506 and 508 to input channel item “Current” 504 and output channel “Voltage” 507 respectively. As a last step the user adds an analysis item 524 to a protocol item 501 by selecting “Add analysis” command from the item 501 pop up menu. The analysis item 524 is created together with all the children items shown on the figure. When the analysis item is created the “X value” item 525 is automatically set to the value “Step voltage” based on knowledge that only “Step” event 512 contains variable value for output channel “Voltage”. Based on the same knowledge the “Start” reference item 526 is automatically set to reference to the “Start” event with adding “Reference” item 527 with value set to “Step”. The “End” reference item 528 is automatically set to the next event, “Done” in this example.

6. Storage

A collection of protocols used for a single recording session is stored in a computer file in the serialized form. Such protocols file can be transferred to a different recording system.

Multiple users sharing the system can each have a separate protocol file. During the recording the recorded data are written into a data file together with the information describing the data and recording conditions. This information is placed into a properties hierarchy of objects with classes inheriting from the Data 203 class. For each execution of the protocol described by ProtocolUnit object an object of class Recording derived from Data is created which is a parent object for all information items related to data recorded during this execution of the protocol. A copy of the ProtocolUnit object that define the protocol is added as a child to the Recording object. The hierarchy of Recording objects is saved into data file in serialized form together with the data. The contents of the data file is represented in GUI as a tree control as described in section 4. The ProtocolUnit object in the file view can not be modified or removed from the Recording object but can be hidden at the user request.

7. Generalizations

The above described embodiment does not cover all possible applications of the invented protocol representation because for illustrative purpose some elements are presented with a narrowed concrete scope. This includes Channel class which in general shall be considered a subclass of more general Resource class. The Resource class may represent any subsystems that may generate, consume or modify the data in the system. Other resources that may be included into protocol hierarchy may be hardware co-processor units that may perform filtering, conversion, encryption, analysis of the data. Thus the Analysis class described above may be implemented as a subclass of the Action class and represent an action that is performed on a resource representing analysis unit. Such analysis action can be added to any event requesting the analysis to be started at the moment of time of that event.

Another kind of resources that can be explicitly specified in a protocol can be timing facilities such as hardware timers or counters. These resources can be used to specify time moment for events or they can be used to specify additional delay for actions on other resources.

1. A method for controlling the operation of a data acquisition and control system comprising the steps of:
(a) providing a memory to store data objects that describe properties of a sequence of actions to be performed by said system during operation,
(b) maintaining hierarchical relations of said data objects such that two data objects may relate to each other as one being a parent of another and the other being a child of the former so that any data object may relate to only single parent and to multiple children,
(c) providing a display for displaying said data objects and said hierarchical relations to a human operator in a graphical form,
(d) providing an input means for said operator to issue commands applied to said data objects and said system,
(e) providing a means to execute command applicable to said system for creating a new protocol which is a data object that together with its descendant data objects contain all necessary information about how the system shall perform a sequence of action during operation,
(f) providing a means to execute commands applicable to said protocol or its descendant data objects for creating descendant data objects, deleting and modifying of said data object, wherein some of said commands are for creating a resource data object descendant to said protocol that together with its descendant data objects contain all information about a subsystem of said system that will be engaged in operation controlled by said protocol, and some of said commands are for creating an event data object descendant to said protocol that together with its descendant data object contain information about moment of time when said system or some of its subsystems shall perform some actions during operation controlled by said protocol, and some of said commands are for creating an action data objects descendant to said protocol that together with its descendant data objects specify an action to be performed by said system or some of its subsystems that are specified by one of said resource data objects that is referenced by on of the descendant data objects of said action data object and said action shall be performed at a certain moment of time that may be specified by some of said event data objects,
(g) providing a means to execute a command applicable to said protocol that will cause the system to start performing the sequence of actions according to said protocol,
whereby said operator can create, modify and examine different sequences of actions and make said system execute said sequences.

2. The method of claim 1 wherein any of said action data objects may be descendant only to one of said event data objects and the action specified by said action data object and its descendant data objects shall happen at the moment of time that is specified by its ascendant event data object and descendant data objects of said event data object.

3. The method of claim 1 wherein some of said resource data objects with their descendant data objects describe the properties of one of data transfer channels for input into the system or output from the system and said action data objects together with their descendant data objects that reference this data transfer channel resource specify action for either transferring a single data value, starting a transfer of data series or stopping the transfer of data series.

4. The method of claim 3 wherein some of said action objects together with their descendant data objects describe a data processing operation performed on data transferred through the said data transfer channels or data resulted from other data processing operation.

5. The method of claim 3 further including step of providing means to store the data that was input into the system during the system operation according to said protocol into the file in the memory together with a copy of said protocol data object and its descendant data objects whereby said data can be read from said file later for further analysis and the moment of time when any portion of data was input into the system can be deduced from said copy of protocol.

6. The method of claim 1 further including a step of providing a means to execute a command applicable to any data object having descendant data objects to toggle displaying of said descendant data objects on said display in such a way that when said descendant data objects of said data object are not displayed the display of said data object is modified to indicate that its descendants are not displayed but it is possible to display these descendants by executing said command.

7. The method of claim 1 further including a step of providing means to assign a default value to a property of the data object in situation when said object does not include a descendant data object describing said property.

8. The method of claim 1 further including a step of providing means to specify a reference moment of time for said event data objects as either the moment of start of protocol execution or the moment of time specified by any other event data object in the same protocol.

9. A machine for controlling the operation of a data acquisition and control system comprising the following parts:
(a) a memory to store data objects that describe properties of a sequence of actions to be performed by said system during operation with said data objects are involved in hierarchical relations such that two data objects may relate to each other as one being a parent of another and the other being a child of the former so that any data object may relate to only single parent and to multiple children,
(b) a display for displaying said data objects and said hierarchical relations to a human operator in a graphical form,
(c) an input means for said operator to issue commands applied to said data objects and said system,
(d) a means to execute a command applicable to said system for creating a new protocol which is a data object that together with its descendant data objects contain all necessary information about how the system shall perform a sequence of action during operation,
(e) a means to execute commands applicable to said protocol or its descendant data objects for creating descendant data objects, deleting and modifying of said data object, wherein some of said commands are for creating a resource data object descendant to said protocol that together with its descendant data objects contain all information about a subsystem of said system that will be engaged in operation controlled by said protocol, and some of said commands are for creating an event data object descendant to said protocol that together with its descendant data object contain information about moment of time when said system or some of its subsystems shall perform some actions during operation controlled by said protocol, and some of said commands are for creating an action data objects descendant to said protocol that together with its descendant data objects specify an action to be performed by said system or some of its subsystems that are specified by one of said resource data objects that is referenced by on of the descendant data objects of said action data object and said action shall be performed at a certain moment of time that may be specified by some of said event data objects,
(f) a means to execute a command applicable to said protocol that will cause the system to start performing the sequence of actions according to said protocol,
whereby said operator can create, modify and examine different sequences of actions and make said system execute said sequences.

10. The machine of claim 9 wherein any of said action data objects may be descendant only to one of said event data objects and the action specified by said action data object and its descendant data objects shall happen at the moment of time that is specified by its ascendant event data object and descendant data objects of said event data object.

11. The machine of claim 9 wherein some of said resource data objects with their descendant data objects describe the properties of one of data transfer channels for input into the system or output from the system and said action data objects together with their descendant data objects that reference this data transfer channel resources specify action for either transferring a single data value, starting a transfer of data series or stopping the transfer of data series.

12. The machine of claim 11 wherein some of said action objects together with their descendant data objects describe a data processing operation performed on data transferred through the said data transfer channels or data resulted from other data processing operation.

13. The machine of claim 11 further including a means to store the data that was input into the system during the system operation according to said protocol into the file in the memory together with a copy of said protocol data object and its descendant data objects whereby said data can be read from said file later for further analysis and the moment of time when any portion of data was input into the system can be deduced from said copy of protocol.

14. The machine of claim 9 further including a means to execute a command applicable to any data object having descendant data objects to toggle displaying of said descendant data objects on said display in such a way that when said descendant data objects of said data object are not displayed the display of said data object is modified to indicate that its descendants are not displayed but it is possible to display these descendants by executing said command.

15. The machine of claim 9 further including means to assign a default value to a property of the data object in situation when said object does not include a descendant data object describing said property.

16. The machine of claim 9 further including means to specify a reference moment of time for said event data objects as either the moment of start of the protocol execution or the moment of time specified by any other event data object in the same protocol.
